(19) United States
(12) Patent Application Publication
(10) Pub. No.: US 2020/0192897 A1
(43) Pub. Date: Jun. 18, 2020

(54) GROUPING DATASETS

(71) Applicant: Infosum Limited, Basingstoke (GB)

(72) Inventors: Nicholas Halstead, Hook Hampshire (GB); Eike Spang, Basingstoke (GB)

(21) Appl. No.: 16/644,211

(22) PCT Filed: Aug. 10, 2018
(86) PCT No.: PCT/EP2018/071822

§ 371 Date: Mar. 4, 2020

(30) Foreign Application Priority Data
Sep. 12, 2017 (GB) 1714655.6

(51) Int. Cl. G06F 16/2458

(52) U.S. Cl. CPC G06F 16/2471

(57) ABSTRACT

A method of accessing a group (Γ) of multiple independent databases (A-E) with an input query to obtain an aggregated output. A first database of the group is searched using the input query to obtain a first set of result entries corresponding to a first set of identifiers in the first database. The result entries of the first set are aggregated into bins defined in the input query according to the attributes of the entries. An indication of the first set of identifiers of the result entries is provided to a second database of the group using a second set of identifiers of entries in the second database for entries which excludes duplicate identifiers in the first and second sets. The second database is searched to obtain a second set of result entries. Finally, result entries of the second set of result entries are added to the bins according to their attributes.

### FIELD

The present invention relates to accessing a group of multiple independent databases to provide a response to a query.

### BACKGROUND

It has long been the case that it has been possible to query databases holding data to provide a response to the query. Queries are run on databases to find a match for the information being requested responsive to the query. For example, a user providing the query might want to know how many entries in a particular database satisfy a particular requirement, such as an age range or gender requirement. There are numerous techniques available to handle this.

As the demand for information grows, it is increasingly the case that a single database may not contain enough information to satisfy a particular query in a particular context. Datasets may be small and/or incomplete. There is therefore a rising demand to enable a query to be run against more than one database to obtain a set of results arising from querying all of the databases.

One technique which is currently available is to firstly merge together two independent datasets so that they exist as a single dataset which can then be queries as one. This procedure can require the transfer of large amounts of data and a complex merging exercise at the receiving end.

Sometimes, databases are available within a single ‘system’ such that they can be in direct communication. A technique exists to query across such databases. For this technique, it is necessary to give full read access to the databases to allow the querying. This means there is no way of controlling the queries that are made on individual databases and therefore there is no way to keep the data secure. This kind of technique is not suitable for databases held by independent owners, who may not wish their data to move out of the database or to be accessible in a common system.

In one known arrangement for querying multiple databases, data from each database are collected into a single database. This puts limitations on how the data can be joined and analysed. In another, data is moved either physically or over the Internet exposing it a variety of security risks. Virtualisation techniques also exist to collect together data from different datasets into one single virtualised place. This does not solve the preceding problems.

Further disadvantages of the known techniques include the fact that data quickly becomes less valuable and useful as it goes out of date. This means that where data is collected into a single dataset from multiple independent databases, this has to be an ongoing procedure. Increasingly, privacy restrictions surrounding data mean that providing data from one database into a combined database can come with restrictions around privacy issues.

### SUMMARY

Embodiments of the present invention which are described herein address some or all of these issues.

It is often valuable to bring together data across a group of databases, but in many scenarios that can be difficult to do as commercial restrictions mean unwillingness to share data between the owners of the respective databases that it may be valuable to group. As mentioned above, one traditional solution is to centralise the data from a number of different databases with a third party. Aspects of the present invention allow a group of independent databases to be accessed without requiring a third party to be involved and without ‘pooling’ the data in a central location. Instead, some factors of the processing are done at the source of the data. A particular issue that can arise when accessing a group of multiple independent databases is that the databases may contain duplicate entries. A duplicate entry is one which is shared between at least two databases in the group. In traditional solutions, when data is brought together from a group and centralised, a de-duplication process can be carried out in a centralised way. However, when the data from the individual independent databases is not to be moved, de-duplication cannot be carried out in this way. Therefore, according to aspects of the present invention, de-duplication is carried out as each database within the group is accessed.

Another particular advantage of the system described herein is that once a group of member databases has been defined, it can operate like a single ‘node’ within a network of databases (which could be single independent databases or other databases joined as a group). Thus, this provides a huge amount of flexibility for accessing any of the data set or any other combination of data sets within a network which a central controller has access. For example it allows groups of data to be joined to other data sources, groups of data to be joined to other groups and groups to be joined via individual data sets or any other combination of the above.

A particular context for using a group of independent databases is in a data joining system which enables a single query with multiple expressions to utilise different, independent data sets without data from the independent datasets being transmitted between them. Such a data joining system is described in our UK Patent Application No. 1620010.7 and presented by way of background herein.

For example, a source database (e.g. finance) might want to run a query against multiple retailer databases which can be considered as a group. This results in a requirement for the deduplication to avoid entities in the intersection of databases within the group being counted twice. A technique has been developed involving filter tokens.

There are a number of different scenarios in which groups can be utilised. The term import query used herein defines any input to a group. Where a group is a ‘source’ group the import query may simply define members of the group and give some indication as to a required output. That output could be for example the definition of attributes to define particular bins. These attributes could be a range of values (for example an age range), or a binary indication (for example gender). In some cases however the import query may include a query expression against which the group is to be searched. In that case, a search of the group would outputs a de-duplicated set of entries across the group which matched the input query expression. The input query expression may be a filtering expression or a target expression, as such terms are used in the following description. A query expression could be for example to define a particular age range or salary range for which outputs are to be generated.

The output of a group may be different in different cases. In one case, the output may be a group of aggregated result entries organised by bins as defined in the import query. Note that this aggregation could occur as each set of result entries is supplied from each database at the database which supplies the set of entries, or it could be carried out at a central controller as each database within the group supplies its result entries back to the controller. Another form of output from the group is a list of de-duplicated entries across the group matching a particular input query expression.

Result entries can take different forms. According to one form of output, each bin contains an aggregated number of entries fitting into that bin. In another output, each bin contains an indication of a set of identifiers which fit into that bin. The indication could for example be a list of hashes or Bloom filter of identifiers fitting into that bin. This allows those entries to be used in subsequent analysis to provide multiple dimensions for the outputs.

A particular advantage of the system described herein is a grammar that has been developed so that a group can be treated by the central controller as though it is a single database. Once a group has been defined in the input query, the dynamics of the group enable the central controller to provide an input query to the group as though it was a single database and to receive results from the group accordingly. The analytical function of the results may vary, but this can be taken into account by recognising that a group has been identified in the query.

According to a first aspect disclosed herein, there is provided a method of accessing a group of multiple independent databases with an input query to obtain an aggregated output from the group, the method comprising: searching a first database of the group using the input query to obtain a first set of result entries corresponding to a first set of identifiers in the first database; aggregating the result entries of the first set into bins defined in the input query according to the attributes of the entries; providing an indication of the first set of identifiers of the result entries to a second database of the group having a second set of identifiers of entries in the second database; searching the second database, using the input query, for entries which excludes duplicate identifiers in the first and second sets to obtain a second set of result entries; and adding to the bins result entries of the second set of result entries according to their attributes.

In an example, the input query is transmitted from the first database to the second database. In another example, the input query is transmitted in parallel to each database in the group. That is, the input query can either be passed around the group from database to database, or provided to each database individually, e.g. by a central controller.

In an example, member databases of the group share at least one category of entries.

In an example, the input query contains the query expression and the result entries of each database match the query expression.

In an example, the method comprises a step of defining the group from a network of multiple independent databases for a period of a query. That is, the group may be defined dynamically for a particular querying instance.

In an example, the method comprises the step of defining the group automatically by selecting databases from a network of multiple independent databases based on a property of the input query.

In an example, the group is specified in the input query.

In an example, the group is defined in a parameter associated with the input query.

In an example, the method comprises the steps of receiving the indication of the first set of identifiers from the first database at a controller, and transmitting the indication from the controller to the second database.

In an example, the method comprises the step of transmitting the indication of the first set of identifiers from the first database to the second database.

In an example, the bins are statistical bins, and each bin contains result entries with attributes in a predefined parameter range for that attribute.

In an example, each bin contains result entries of a defined attribute.

In an example, the method comprises a step of applying a redaction threshold of a minimum number of entries per bin to an aggregated set of result entries from all members of the group.

In an example, the method comprises a step of applying a redaction threshold of a total minimum number of result entries.

In an example, the step of providing an indication of the first set of identifiers comprises providing the identifiers in a hashed form or as a bloom filter.

According to a second aspect disclosed herein, there is provided a method of accessing multiple independent databases with a single query having multiple expressions, the method comprising: deriving from a single query at least one filtering query containing at least one filtering expression and a target query containing at least one target expression, wherein the at least one filtering expression is used in a method according to the first aspect in the input query to access the group of databases and wherein, the second database is a target database which is searched the target expression.

According to a third aspect disclosed herein, there is provided a method of accessing multiple independent databases with a single query having multiple expressions, the method comprising: deriving from the single query at least one filtering query containing at least one filtering expression and a target query containing at least one target expression; searching a first one of the multiple independent databases using the at least one filtering query to obtain a filtering set of target entries matching the at least one filtering expression; applying identifiers only of the filtering set of target entries and the target query to a group of multiple independent databases in accordance with a method of the first aspect, wherein the target expression is in the input query for the group.

In an example, each bin contains an aggregated number of entries.

In an example, each bin contains an indication of a set of identifiers in that bin.

In an example, member databases of the group contain entries in the same field of use.

In an example, duplicate identifiers are excluded by comparing the indicating of the first set of identifiers with the second set of identifiers prior to the step searching the second database, wherein the step of searching the second database applies only additional identifiers in the second set and not in the first set.

In an example, duplicate identifiers are excluded by comparing each identifier of the second set with indication of the first set while searching the second database.

According to a fourth aspect disclosed herein, there is provided a computer program product comprising computer-executable code embodied on a computer-readable storage medium, configured so as when executed by at least one processor to perform the method steps of the first, second, or third aspect.

According to a fifth aspect disclosed herein, there is provided a computer device for accessing a group of multiple independent databases with an input query to obtain an aggregated output from the group, the computer device comprising at least one processing configured to: search a first database of the group using the input query to obtain a first set of result entries corresponding to a first set of identifiers in the first database; aggregate the result entries of the first set into bins defined in the input query according to the attributes of the entries; provide an indication of the first set of identifiers of the result entries to a second database of the group having a second set of identifiers of entries in the second database; search the second database, using the input query, for entries which excludes duplicate identifiers in the first and second sets to obtain a second set of result entries; and add to the bins result entries of the second set of result entries according to their attributes.

According to a sixth aspect disclosed herein, there is provided a method of extracting data from a dynamically defined group of multiple independent databases in a common field of use, wherein each database is owned by a data owner and holds data entries each having a key and a parameter in at least one category, wherein data entries of each database are constrained from being transferred to another data owner, the method comprising: accessing a first one of the databases to extract results based on an input query defined for the dynamically defined group to produce a first set of results in the category; accessing a second one of the databases to extract results based on the same input query, while de-duplicating keys returned from the first database, to produce a second set of results in the category; and aggregating the first and second sets of results without identifying the origin database of each result into an aggregated set for that category.

### BRIEF DESCRIPTION OF DRAWINGS

For a better understanding of the present invention and to show how the same may be carried into effect, reference will now be made by way of example to the following drawings.

FIG. 1 is a schematic diagram illustrating a data joining system at a high schematic level;

FIG. 2 is a diagram illustrating a method of data joining;

FIG. 3 is a schematic diagram illustrating a specific example where customers' transaction data is joined with their corresponding demographics data from two independently controlled databases;

FIG. 4 is a schematic diagram illustrating a possible architecture of a data joining system.

FIG. 5 is a flowchart illustrating processes carried out at a central controller;

FIG. 6 is a schematic diagram illustrating the flow of FIG. 5;

FIG. 7 is a more detailed architectural diagram of a computer system for accessing multiple independent databases;

FIG. 7a is an example of a configuration for importing data into a mirror database;

FIG. 8a and FIG. 8b are diagrams illustrating filtering expressions with logical operators;

FIG. 9 is a diagram illustrating the process of querying multiple drones with a single joining key;

FIG. 10 is a diagram illustrating the process of querying multiple drones with a single joining key;

FIG. 11 shows an example output of a user screen;

FIG. 12 shows another example output of a user screen;

FIG. 13 shows yet another example output of a user screen;

FIG. 14 is a schematic diagram showing a set of independent databases in which a group of databases has been identified;

FIG. 15 is a Venn diagram illustrating one example of data entry overlap between multiple databases;

FIG. 16 is a schematic diagram illustrating querying of a group of databases;

FIG. 17 is a schematic diagram illustrating an example of how a group of databases can be queried; and

FIGS. 18a-g are schematic diagrams illustrating use causes for groups.

### DETAILED DESCRIPTION

Nowadays every company holds valuable data, for example concerning attributes of consumers or potential consumers who may wish to access that data. Sharing customer data among different companies creates complex privacy and legal issues, as the data contained in customer records may be shared involuntarily. The problem is exacerbated by the fact that different departments within the same company, or among different companies may store data at different locations, and thus moving and selling data across sites poses security risks that may result in value leakage. Furthermore, different companies' storage formats are often not compatible and therefore increases the complexity in sharing customer data.

To address these issues, Applicant developed a novel solution which is described in their UK Patent Application No. 1620010.7. This solution is described herein by way of background information.

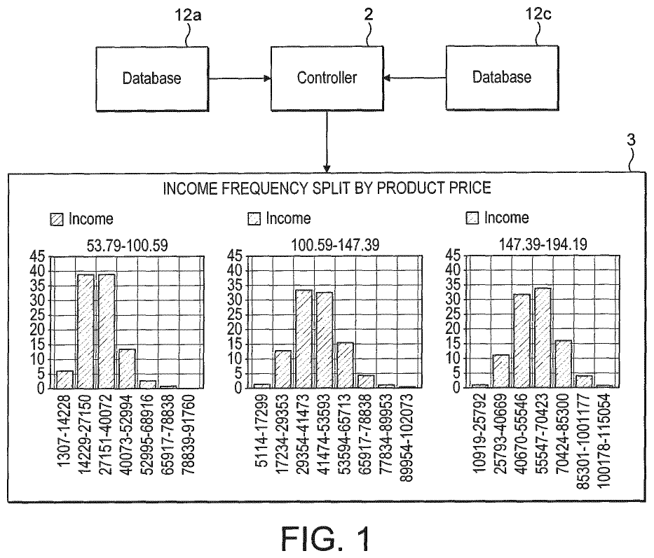

FIG. 1 is a schematic diagram of a data joining system. Reference numeral 12a denotes a first database (e.g. a database of a financial organisation) which holds certain attributes within its records (entries). Reference numeral 12c denotes a second database (e.g. a database of a retail organisation) which holds certain attributes within its records (entries). The attributes in one database may be different to the attributes in the other database. Some entities may exist in both databases, and the challenge is to combine knowledge from both databases by joining data in a fully privacy compliant way without any records leaving each company's data centre. Reference numeral 2 denotes a controller which provides such a data joining service. An example output graph visible to a user is denoted by reference number 3; in this example it provides information on the spending habit of customers categorised by their annual income.

The terms database and datasets are used interchangeably herein to denote a structured set of data records. In practice a dataset may comprise multiple databases under a common control (not independent).

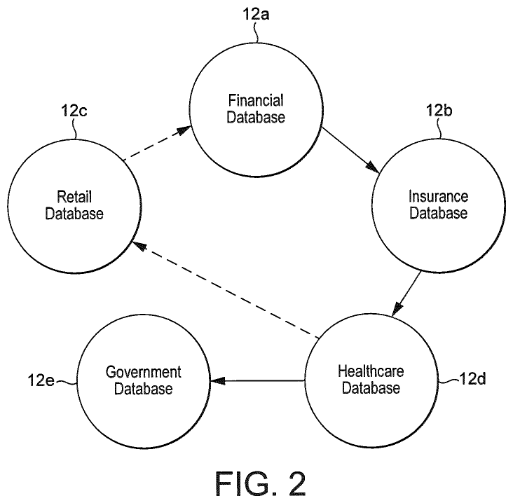

FIG. 2 shows schematically how data joining works for a data joining system with three organisations (Healthcare, Retail and Financial) shown by the dotted arrow, and for four organisations shown by bold arrows (Government, Healthcare, Insurance and Financial). In any case, queries can be, created according to the existing datasets at each of the queried companies, in order to fully utilise all of the data available. A suitable filter, such as a list of hashes or Bloom filter, is created from a first query to be applied to one or more of the fields within each dataset to filter entries to be checked against a second query. Those entries in the dataset matching the second query ran against the filtered entries are then sent back to the cloud as returned data. The joining of combined datasets creates greater knowledge than a single database can offer on its own and in some cases allow new datasets to be created. Common identifiers (or joining factors), such as email address and telephone number, are used to identify data associated with a particular entry across different datasets. In some cases different common joining factors may be used depending upon their availability in the target datasets. The final results as presented to the user can be originated from any one of the queried organisations, but each of the returned data results can be configured to meet individual privacy/redaction policies.

Data joining as described herein may be employed to join internal data from databases belonging to the same entity, external data from databases owned by a plurality of entities, or data from databases physically located across different countries. For example when joining internal data, the data joining system provides a solution to combine datasets that are not allowed to be cross-contaminated, or are intentionally segregated by access restrictions, internal policies and regulations. It is also useful for joining many internal databases that are too large to be managed in a single instance, or combine knowledge of different databases across a large corporation. When deployed to join external datasets, the data joining system allows the companies to benefit from pooling their knowledge and therefrom creates new datasets, as well as to acquire knowledge of sensitive data that would not normally be shared. Furthermore, the data joining system allows data to be sold into newly created market places. In some cases the use of the data joining system overcomes juridical restrictions and allows data to be exported from a particular jurisdiction. The data joining system is also useful for joining datasets that are time consuming to synchronise or technically impractical to move among different countries.

Databases which can be accessed using the data joining service form a data joining network. As more companies subscribe to the data joining network, they each form a node on the network and become a part of a combined dataset that incorporates many small datasets, e.g. the data joining network may act as a central database. Furthermore, there is no limit to the number or size of the combined datasets across the subscripting companies, whilst each of them remain in control of who they wish share their knowledge with.

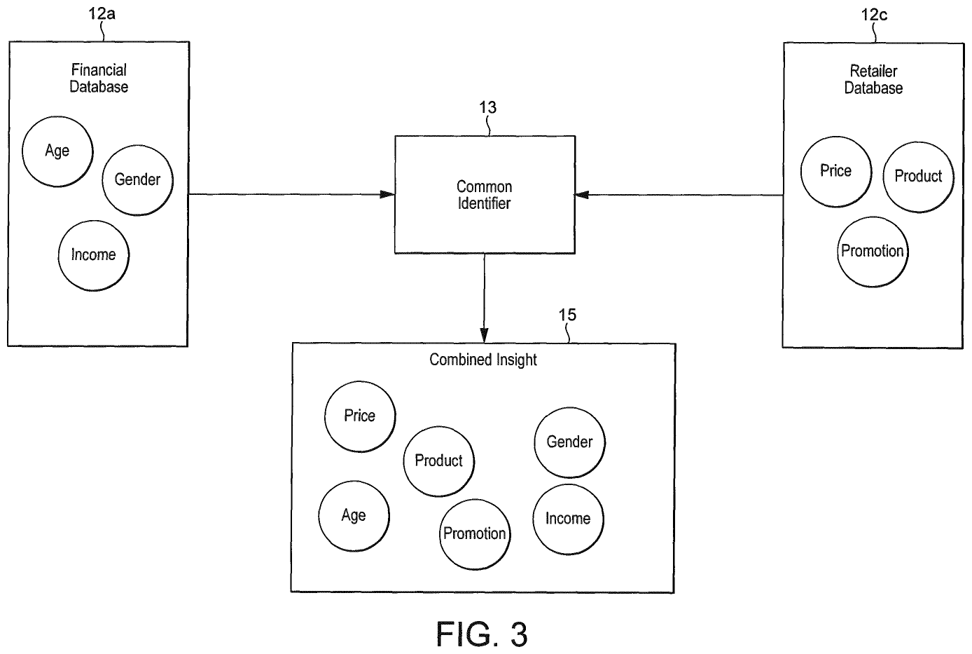

FIG. 3 illustrates a specific example where a retailer cross-examines customers' transaction data and purchase history (e.g. price, product and promotion of past purchases) with their corresponding demographics data (e.g. age, gender and income) from a bank's dataset, using email addresses as a common identifier 13 (or joining factor). This provides a combined insight of customers 15 and allows the retailers to create bespoke promotion strategies for their target customers. For example, the combined dataset between the bank and the retailer reveals which promotions are used most frequently by different aged customers and based thereon tailor promotion strategy.

The novel solution offers a secure data sharing among different databases. In cases where the returned data is given in statistical form, customer records associated with the returned data never leave the owners' database. Moreover, the statistical data can comply with redaction rules to protect each individual customer's identity. Redaction control can be applied over the whole database or individual data fields.

The controller 2 can be embodied in the ‘cloud’ to provide a cloud service that facilitates data joining. The cloud service stores instructions for data acquisition (e.g. filtering expressions), but not the actual returned data. Moreover the queries can be controlled in real time and so they can be terminated as required.

In terms of access control, each sharing database is given its own set of access control so to allow bespoke control on who they wish share their knowledge with. This prevents accidental sharing of commercial sensitive data that would otherwise be detrimental to the owner of the sharing database. Restriction may also be imposed on queries requesting sensitive combination of fields in the dataset.

The data joining system allows data from multiple discrete databases to be combined, allowing different owners of databases to consent to mutual use of each other's data without compromising security of their own database or anonymity.

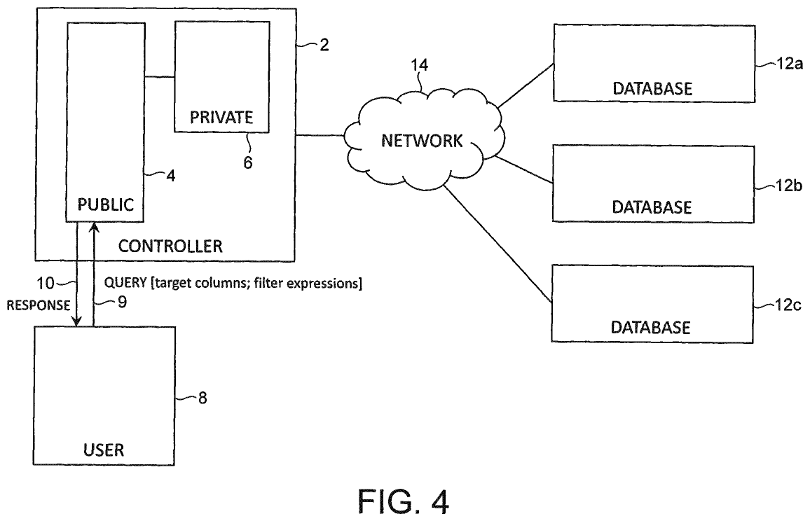

FIG. 4 is a more detailed schematic block diagram of a system in which data from multiple discrete databases can be combined upon receiving a query from a querying user. The system comprises the central controller 2 which has a publically accessible component 4 and a set of private components 6 which implement a data combining process. The central controller can be implemented by software, firmware or hardware or any combination thereof. It could be a single server executing a computer program, or distributed over multiple servers, each running an installed computer program, autonomously or in a distributed computing fashion. A user 8 has access to the controller 2 via a public interface, for example, which can be an application programming interface (API) in the controller 2. A user could be in contact with a controller 2 in any other way. Reference to a user herein refers to a user and/or a user device which can be any suitable computer device capable of generating and exchanging electronic messages. In particular, a user can generate a query 9 which he wants to run over multiple databases. That query can be generated by a human user providing manual input at an interface of a computer device, or it can be generated autonomously and automatically by a computer device itself.

Example queries are given later, together with examples of results of the queries delivered to the user.

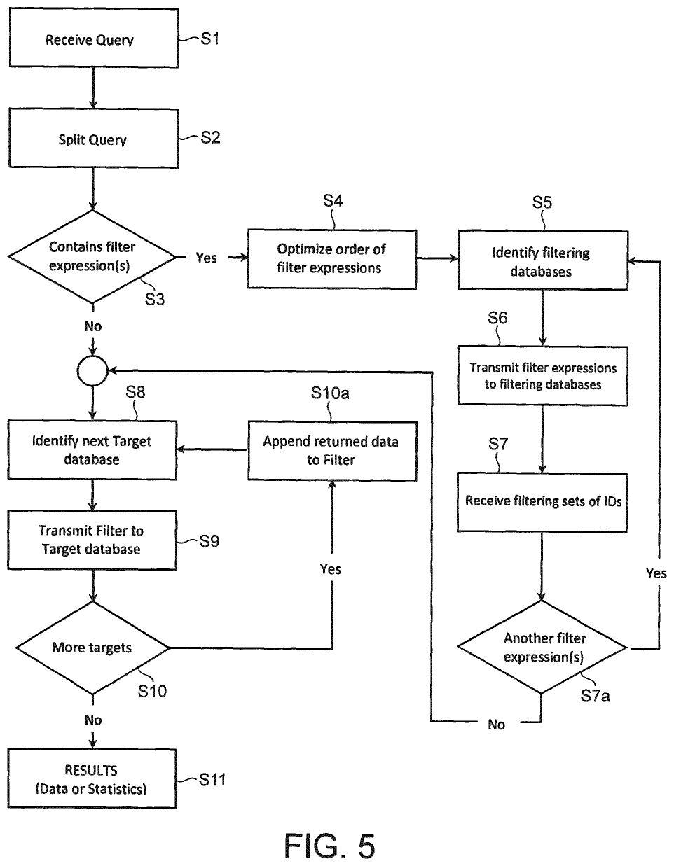

The user 8 receives a response 10 following data combining processes carried out at the controller 2. The response 10 can take the form of a set of target entries resulting from combining the entries in the databases which satisfy expressions in the query. Alternatively, the response 10 can take the form of aggregated data as described in more detail herein, shown for example in a graphical format. The controller 2 is connected to multiple databases 12a, 12b, 12c. It can be connected via any suitable communication network 14, which could be a private Intranet or public Internet. Before going into a more detailed description of the architecture of the system, the basic principles of the data combining process will now be described. For this, reference is made to FIG. 5.

As illustrated in FIG. 5, the first step of the process is the receipt of a query by the central controller 2 from the user 8, step S1. The query 9 comprises one or more target “columns” to receive data or statistics, and a set of filter expressions which the data or statistics should satisfy. For example, the query could ask for the number of data entries satisfying a certain age range and certain gender specification. Some examples are given later by way of illustration not limitation.

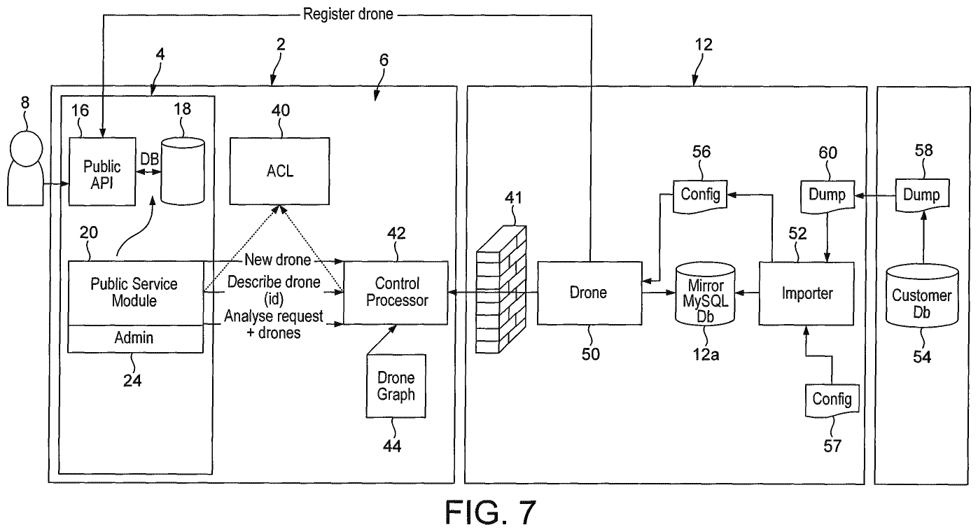

At step S2, the query is split into two queries, which are referred to herein as a filtering query and a target query. At step S3, a check is made to see whether or not the filter query contains filter expressions. If it does, the flow moves to step S4 where an order of the filter expressions is optimised. The purpose of this optimisation is to determine an order in which filter expressions are to be submitted to one or more database, as discussed in more detail later. At step S5 filtering databases are identified, each database being selected as the most appropriate database to deal with the particular filter expression. The central controller 2 stores information about all the databases to which it has access to allow it to identify appropriate filtering databases. This information is stored using a drone graph (44 in FIG. 7) described later. Each database is associated with a drone, which serves as a database agent on the software side. For example, the controller can identify which of the databases contains information related to the required filtering expression. At step S6, each filter expression is sent to the most appropriate database. When the first filter expression is sent to the first filtering database, it is run against the database to identify entries in that database matching the terms of the filter expression. For example, if the first required expression is an age range between 18 to 25, a filtering set of identifiers is returned from that database identifying database records satisfying the expression, for example, all the entities in the database aged between 18 to 25. Thus, the age range has produced a filtered set of identifiers. This filtered set can then be transmitted to a subsequent filtering database to act as a filter along with the next filter expression of the query, wherein the next filter expression is compared only to the entries in the database which satisfy the identifiers of the filtered set. Step S7 denotes the function of receiving the filtering sets of IDs, and step S7a the determination of whether there are additional filtering expressions. Once all filtering expressions have been utilised and run against their respective filtering databases, a final filtered ID set is produced. The process then moves to step S8 where a target database is identified for execution of the target query. For example, the target query in this case could be gender-based, for example, identify all females. In step S9, the filtered dataset and the target query are applied to the identified target database where the target query is run only against the identifiers which satisfy the identifiers in the filtered dataset. Note that a single filter expression can be sent to multiple databases, or multiple filter expressions can be sent to a single database. Note also, that in some cases there may be no filtering expressions (step S3) in which case the target query is just passed straight to one or more target database. It is important to recognise that no data records are transferred, only record IDs.

Note that there may be more than one target database, as well as or instead of, multiple filtering databases. Thus, a database could both produce a result set of record data and a filtering set of identifiers for a subsequent query. Note that one expression may be run against multiple databases, for example when more than one database satisfies the expression, but perhaps with incomplete records.

Step S10 checks for whether there are any more target queries or more target databases that need to be addressed with the target query and in the case that they are, the returned data is appended to the filter S10a and steps S8 and S9 run again on the next target database.

When all target databases have been queried, the final results are returned in step S11. Note that the results may be actual data entries, or aggregated statistics, depending on the context in which the method is applied. For example, “real data” could be provided in the results in a company internal implementation, while aggregated statistical results could be provided for public usage, for reasons of security and anonymity.

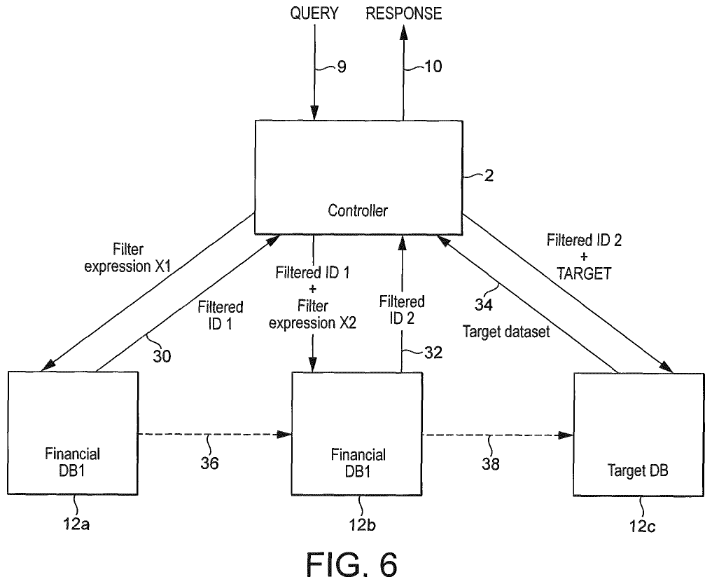

FIG. 6 is a schematic architectural diagram which gives one example of the flow described with reference to FIG. 5. As shown in FIG. 6, a query 9 is received at the controller 2. In this case, the controller 2 splits the query into three separate queries, a first query with a first filter expression X1, a second query with a second filter expression X2, and a third target query with a target expression TARGET. As an example, the first filter expression could be an age range (e.g. between 18 to 25), the second filter expression could be income (e.g. more than £60,000) and the target expression could be gender (i.e. all females). The first query with the first filter expression X1 is sent to the first database 12a of a financial organisation labelled Financial DB1. This database is determined by the controller as being the best database for establishing data entries fitting a certain age range. A filtered set of IDs 1, 30, is returned to the controller 2. This filtered ID set includes record identifiers or records from the filter database Financial DB1 satisfying the first filter expression (that is, all data entries fitting the age range between 18 to 25). The filtered ID set 1 can comprise a list of hashed identifiers, where each identifies a data entry in the database, or can be a bloom filter or the like.

A bloom filter is commonly applied to test whether an element is a member of a set. It consists of a set of positions which can be set to ‘1’ or ‘0’ depending on whether the position is occupied. In the present context, the positions represent identifiers, and each identifier identifies one or more rows of the database. More specifically, a bloom filter tests whether an element is certainly not present and therefore removes the need to seek elements that don't exist in a set. A bloom filter query returns a result of either “possibly in set” or “definitely not in set”. A bloom filter is particularly useful if the amount of source data would require an impractically large amount of memory if “conventional” error-free hashing techniques were applied. Moreover, the original used list of hashes cannot be generated from the filter, so it provides another level of anonymity.

The filtered ID set 1 and the second query with the second filter expression X2 is then addressed to the second database 12b of another financial organisation labelled Financial DB2. This database has been identified by the controller as being a good database for extracting income-related data.

The query which is run over the second filter database is a query which matches the second filter expression X2 against only those database entries identified by the filtered ID set 1. This is therefore potentially a faster query to run and might reduce the amount of data to transfer. Moreover, note that there has been no requirement to “join” the records of the first and second filter databases into a common dataset. Thus, these databases can be completely independent, logically and/or geographically and do not have to have any common control or ownership. Note also that no raw data (database records) is transferred.

A second filter ID set 2, 32, is returned to the controller 2 following the query which is run on the second filtering database Financial DB2 12b. The controller 2 sends the second filter ID set 2 and the target expression to a target database which it has identified. The result 34 of running the target expression TARGET against the identifiers in the filter dataset 2 (or the bloom filter) is returned to the controller 2. The controller 2 provides the response 10 to the user, which is either raw data or aggregated data as discussed herein.

As an alternative architectural possibility, the first filter ID set 1, 30 and the second filter ID set 2, 32 do not need to be returned to the controller. Instead, they could be passed directly from the first filter database to the second filter database, and from the second filter database to the target database respectively as indicated schematically by the dotted line arrows 36 and 38 moving to the right in FIG. 6.

FIG. 7 is a more detailed architectural diagram illustrating the component at the controller 2 and at a database site 12. The term “database site” is used herein to denote any site where one or more databases may be located. A database may alternatively be referred to herein as a “customer site”, indicating that the database is owned by a particular customer. One distinct advantage of the described embodiments is that searches may be done across multiple databases which may be individually owned by different customers. One such database site is shown in FIG. 7. The public part 4 of the controller 2 comprises a public API 16 which is connected to a database 18 and to a public service module 20 which provides an administration interface 24.

The public API enables the user 8 to interact with the system. The administrator interface interacts with an access central layer (ACL) components to set up permission, etc. for individual users.

Public parts 4 of the controller communicate with private components within the private part 6. The private components comprise the Access Control Layer (ACL) component 40, and a control processor 42. The access control layer 40 conditions outgoing requests according to the redaction policies of the querying customer and their subscription status. The processor component 42 is responsible for the processing functions which have been described, and for communication with database sites 12. Each database site comprises a firewall 41 for security purposes. The database site 12 incorporates a database 12a (one of the databases that has already been described). The database 12a is associated with a database agent or drone 50 which is the component which acts to facilitate receipt of queries from the controller 2 and the execution of running those queries over the database 12a.

The database site 12 shown in FIG. 7 has a single database and a single drone. However, there may be a plurality of drones provided for a particular site, each associated with a distinct database. In the present embodiment, there is a 1:1 relationship between drones and databases. The database site 12 comprises an importer module 52. The importer module 52 plays the role of importing data from a “raw” customer database 54 into the database 12a, against which queries can be run. A configuration file 57 can be provided for controlling the operation of the importer. For the sake of completeness, reference numeral 58 denotes a database dump received from the customer database 54, and reference numeral 60 denotes the transfer of that database dump into the database site 12 so that it can be provided to the importer module 52. The configuration file which is supplied to the importer can be manually generated or automatically generated. It defines in particular a set of identifiers which are to be used by the database 12a such that all databases against which queries can be run have at least one common identifiers. This could, for example, be personal information such as a name or email address. In addition, certain items of data to populate the data entries may be required by the configuration file. The importer module 52 supplies a configuration file 56 to the drone 50 to inform the drone about the structure of the database 12a against which queries can be run. An example of the configuration file 56 is given in FIG. 7a.

User requests are handled through the public API via the public service module 20 to the control processor 42. The message “analyse request+drones” in FIG. 7 denotes a request from a user to analyse an input query and to identify the appropriate drones to which the split queries should be sent. New drones can be added by the administration interface 24 of the public service module 20. The drone registration process is described later below.

In accordance with embodiments of the present invention, a group of databases can be configured to operate in the same way as a drone of a single database for the purposes of querying. That is, a “group” of databases may be identified and queried by the controller 2 like any other single database, but the group actually comprises plural separate databases (potentially owned and/or managed by different entities). Each of the databases 12a-c could be a set of data entries stored on a single database, or could be a group of databases, managed as described herein.

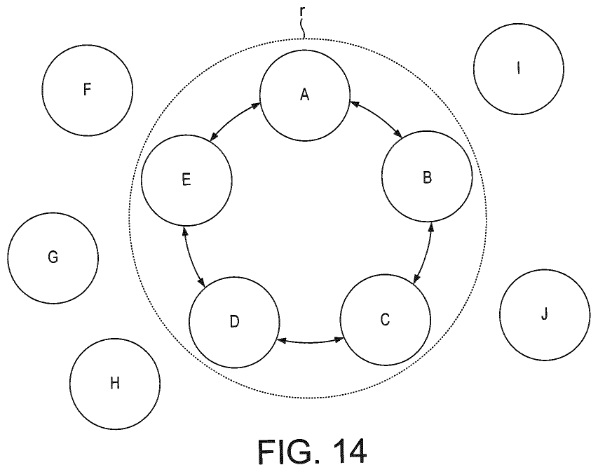

FIG. 14 shows a number of datasets (A-J) all accessible by the controller 2, and potentially available to be accessed singly or as a group. In this case five datasets A-E have been selected to act as a group r, for example the datasets A-E may be datasets of five retailers storing data about their respective customer bases.

Which particular datasets are chosen to act as a group can be predefined (e.g. datasets A-E may be configured to always act as a group), or the datasets used for a given query may be determined dynamically. In the latter case, the group can be defined from a network of multiple independent databases for a period of a query only. I.e. the group is an ad-hoc group which exists (at least conceptually) only while the query is being run. A second query at a later time will result in a new group (though potentially comprising the same datasets) being defined for that query.

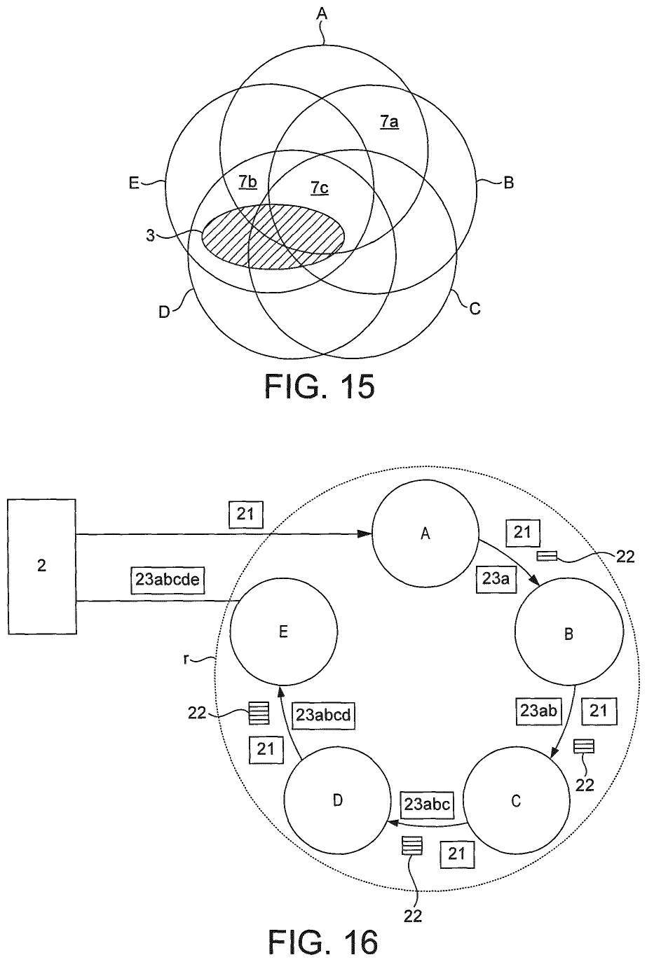

The controller 2 may determine which datasets to use as a group based upon the query itself. The group may be specified explicitly in the query (e.g. Γ=A, B, C, D, E). The controller 2 may instead select the multiple independent databases based on a property of the input query. For example, if the query is for “salary” data, the controller 2 may select a group of datasets (e.g. five datasets) from the network which contain the highest numbers of data entries with salary data available. In doing so, the controller 2 may take data overlap (see FIG. 15 below) into account.

There may be overlap between the entries of each dataset (e.g. a person may be a customer of two or more retailers). This can be visualised in a Venn diagram as shown in FIG. 15.

Data entries of each dataset A-E are represented by a circle encompassing data entries 7 contained in that dataset. As examples: entry 7a is present in both dataset A and dataset B only; entry 7b is present in datasets A, D and E only; and entry 7c is present in every dataset A-E.

Whichever role is performed by a group (the role of the first database 12a, second database 12b, or target database 12c), it is important to de-duplicate entries within the group. In other words, the (portion of) the query cannot simply be naïvely run over the group in exactly the same manner as the database in the example of FIG. 6, because of the possibility for duplicate data entries.

Instead, the input (e.g. query, sub-query, filter, list of IDs, bloom filter) is received by one of the group and passed through all group members to return a result (e.g. a list of IDs, aggregated results, or a bloom filter). The specifics of this process depend on which role the group is playing in the series of databases 12a-c. However, in each case an indication of the data entries already taken into account is kept up-to-date as the operation moves through the group, so that the next database can ignore these data entries (should it contain them).

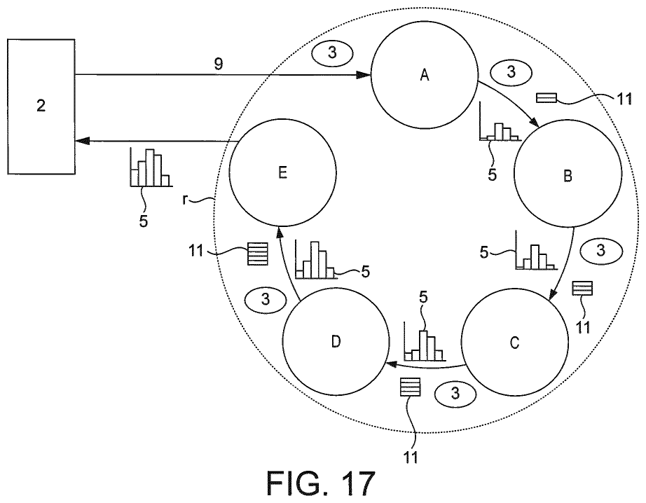

FIG. 16 illustrates this process conceptually. An input 21 supplied to the group r by the controller 2 prompts a first database A in the group r to generate an output 23a, as in a normal querying operation. Database A also generates an indication 22 of the data entries it has taken into account in the generated output 23a. Database A then passes the output 23, the input 21 and the indication 22 to a Database B.

The input 21 similarly prompts Database B to generate an output. However, in this case Database B also knows to not include any of the data entries included in the indication 22. For example, the indication may be a list of usernames. Database B will respond to the input 21 (e.g. for data pertaining to the users) but ignore users in the indication 22 (which have therefore already been taken into account by Database A). Database B produces an output which is aggregated to output 23a, shown as 23ab own result. Database B also updates the indication 22 to further indicate data entries it has included to generate the output 23ab. The input 21 and the (updated) indication 22 are passed to a third database—Database C in this example. Note that the controller could receive and pass these items, or they could go directly to the database. This process continues around the group Γ. The final result is an overall output 23abcde.

As mentioned above, an alternative to moving the output 23 and updating it at each database A-E is for each database A-E to transmit its individual output to the controller 2. In these cases, the controller 2 performs the aggregation operation. For this to work, the databases A-E still pass the indication 22 around and update it accordingly, exactly as described above.

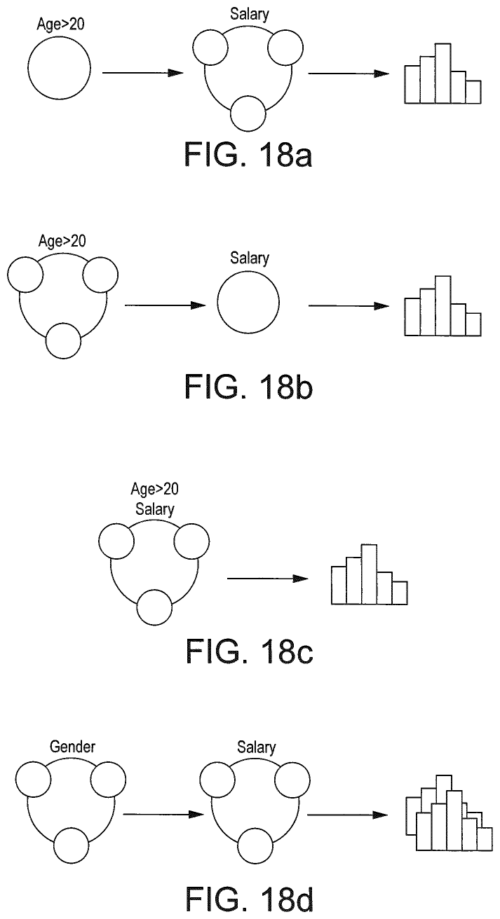

FIG. 17 (described below) shows an illustrative example in which the group F is acting as the target database 12c.

Consider a query 9 such as for user data where age>40. A filter 3 for “age>40” is first applied by accessing each dataset A-E to identify only users older than 40, and then the user data for those users is aggregated. In the example of FIG. 15, the shaded region of the filter 3 therefore represents all users who are older than 40. As at least some of the region of the filter 3 overlaps with multiple datasets, deduplication will be required. In other words, if the filter is naïvely applied to each dataset, some users will be aggregated multiple times.

To solve this, the grouping technique applies the filter 3 to each dataset A-E in the group r in turn, whilst keeping track of which entries have already been aggregated in an anonymised way.

With reference to FIG. 17, the controller 2 can query 9 the group Γ as though it is a single drone using the grammar described below. The controller 2 does not need to be aware that the group Γ is comprised of multiple datasets A-E. The only difference is that an analytical function which aggregates the outputs has one form for an individual database and another form for a group.

The filter 3 is applied to dataset A and the required data (as specified by the query, e.g. for salary data etc.) is aggregated into aggregated result 5 as shown in FIG. 17. A list of hashes 11 (also called hash list 11) is also generated which comprises an indication of which data entries have been included in the aggregated result 5 (so far). In this example the hash list 11 comprises a set of hash values generated from each respective data entry added to the aggregated result 5. However, alternatives exists such as a bloom filter generated from each of the entries added to the aggregated result 5. In general, any data structure can be used which allows the further datasets (as described below) to determine whether a given data entry has been taken into account the aggregated result 5 or not.

The filter 3, and hash list 11 are passed to a second dataset B. The results can be returned to the controller 2 at this point. The second dataset B then applies the filter 3 in the same manner but before aggregating the resulting entries to the result 5 it performs the additional step of using the hash list 11 to check whether a given result has been added to the result 5 yet (i.e. by dataset A in this example). Dataset B only aggregates values from data entries which it determines have not yet already been added.

The filter 3 and, (updated) hash list 11, are then passed to a third dataset C. The results can be returned to the controller 2 and aggregated with the previous result. The same steps (of dataset B) are performed by the third dataset C. This process continues until the final set of results from data set E has aggregated data to the results 5.

Determining the number of unique users across n databases in a group has a number of different applications. For example, the deduplication method can be used for calculating intersections between datasets in a marketplace comprising many datasets. Advantageously, the “de-duplicated intersection” indicating the number of unique data entries in a group of datasets can be determined.

### Grammar

The table below outlines an example grammar for querying in accordance with embodiments of the present invention.

| | |
|---|---|
| <query> ::= | SELECT <select list> <table expression> ‘;’ |
| <select list> ::= | <aggregate function> [{<comma><aggregate function>} |
| | ... ] |
| <table expression> ::= | <from clause> [<where clause>][<with clause>] |
| <from clause> ::= | FROM <drone reference list> \| FROM <query> |
| <where clause> ::= | WHERE <where expression> |
| <with clause> ::= | WITH <drone reference list> |

For example, using the grammar defined in the table above, a query for age distribution in a first database (d1) where gender is female (as stored in a second database, d2) can be specified as:

SELECT DIST(d1.Age)
FROM id1 as d1, id2 as d2
WHERE d2.Gender = ‘female’
WITH id3;

In another example, below, a group g1 is specified from multiple databases id2, id3, id4.

```
SELECT DIST(d1.Age), DIST(d1.Salary)
FROM (
  SELECT DIST(g1.Salary)
  FROM GROUP(id2, id3, id4) as g1
  WHERE g1.Age > 40 and g1.Gender = ‘female’
  )
WITH id1 as d1;
```

A query can be transformed before being applied to the group. Hence, in yet another example, a query may take the form “g1.age>40”. If group g1 comprises databases d1 and d2, this query is first transformed to “(d1.age>40 or d2.age>40)” where “or” is the Boolean OR operation.

The following functions may be performs by drones (various examples are described below):
FETCH: This function returns a set of keys (e.g. unique list of keys, bloom filter etc.). This function takes the wanted keyID and a filter expression as arguments.
ANALYZE: This function returns an aggregated result of a column of the dataset. This function takes the wanted columnID, the bins and a filter expression as arguments.
FETCHGROUP: This functions takes a keyID, a columnID, Bins, a bloomfilter with values that should be excluded, and a filter expression as arguments. The function returns a bloom filter for each bin in Bins of all values fulfilling the filter expression and which are not included in the excluding bloomfilter. In addition to that, the function adds the keys of all of these values into the excluding bloom filter and returns this filter.
ANALYZEGROUP: This function takes a keyID, a columnID, Bins, a bloomfilter with values that should be excluded, and a filter expression as arguments. The function returns an aggregation of all values fulfilling the filter expression and which are not included in the excluding bloomfilter. In addition to that, the function adds the keys of all aggregated values into the excluding bloomfilter and returns this filter.

The excluding bloom filter can be empty/null. The filter expression can be empty, based on a column (e.g. age>40), a set of keys or a combination of those combined by a Boolean AND or OR operation.

A group can be queried to return (binned) data with duplicated removed. Consider the following query, for example to be run on a group Group1 consisting of three drones Drone1, Drone2, Drone3:

### SELECT RANGES(Group1.Age, 0, 20, 30, 40, 100)

### FROM GROUP(Drone1, Drone2, Drone3) as Group1

The controller 2 then performs the following steps:
Get Subgraph with drones Drone1, Drone2, Drone3
Validate subgraph
   Do Drone1, Drone2, Drone3 share at least one key?
   Do Drone1, Drone2, Drone3 have the category “age” and have at least one shared representation?
Call Query Analyze function with parameters “Group1”, R, B and an empty filter expression F. Handle it as a group:
   Choose which Representation R1 should be used for Age in Drone1
   Drone1.AnalyzeGroup(R1, B, null, F) returns an aggregation A1 and a bloom filter BF containing all values added to A1.
   Choose which Representation R2 should be used for Age in Drone2
   Drone2.AnalyzeGroup(R2, B, BF, empty filter expression) returns an aggregation A2 and a bloom filter BF2 containing all values in BF and all value added to A2.
   Choose which Representation R3 should be used for Age in Drone2
   Drone3.AnalyzeGroup(R2, B, BF2, empty filter expression) returns an aggregation A3 and a bloom filter BF3 containing all values in BF2 and all values added to A3.
   Create Aggregate A=A1+A2+A3
   Return A

This way, any repeated data entries (e.g. users present in more than one drone) across the group are only counted once, because they are noted in the bloom filter and purposely not aggregated any further times. The returned aggregate A therefore is “de-duplicated” in the sense that each entry has only been counted once, even if present in multiple ones of the drones in the group.

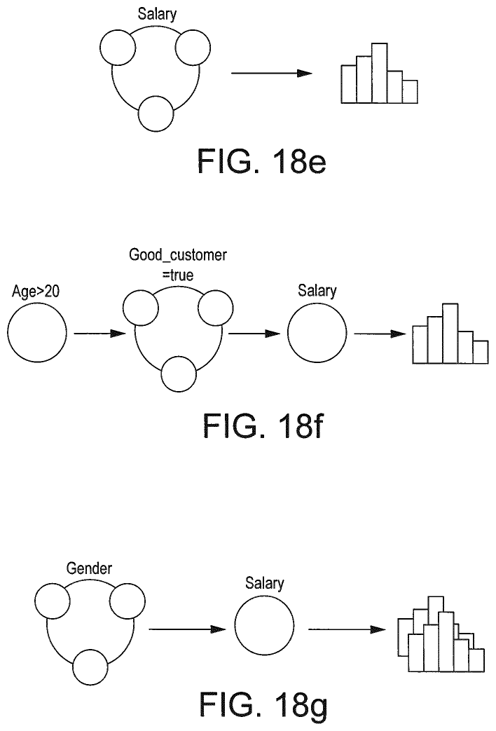

FIGS. 18a to g illustrate schematically different use cases for a group of datasets. According to FIG. 18a, a filter expression (“age>20” in this example) is sent to a drone which generates a list of identifiers. The list of identifiers is then passed to a group to perform an aggregation operation (over “salary” data in this example). The request to the group is that the records for which age is greater than 20 are aggregated and shown as a set of aggregated results grouped by salary.

Consider, with reference to FIG. 18a, a query of the form:

### SELECT RANGES(Group1.Age, 0, 20, 30, 40, 100)

### FROM GROUP(Drone1, Drone2, Drone3) as Group1

### WHERE Drone4.Gender=‘male’

The controller 2 performs the following steps:
Determine a subgraph of drones to work with, in this case Drone1, Drone2, Drone3, Drone4.
Validate subgraph
   do Drone1, Drone2, Drone3 share at least one key?
   do Drone1, Drone2, Drone3 have the category “age” and have at least one shared representation?
   does Drone 4 have the category “gender”?
Call Query Analyze function with parameter “Group1”, R, B and F (‘gender=“male”’). Handle it as a group:
   Create Bins B=[[0,20), [20, 30), [30, 40), [40, 100)]
   Choose which representation R_{Gender} should be used for Gender in Drone4
   Create filter expression F_{Gender} which is equivalent to F
      NOTE: the values might have to be changed to conform with the chosen Representation R_{Gender} [This will be ignored in all following queries]
   Transform F_{Gender} so that it can be used in Drone1, Drone2, and Drone3
   Choose which Representation R_{1, Age} should be used for Age in Drone 1 and Bins B₁
   A1, BF=Drone1.AnalyzeGroup(R_{1,Age}, B₁, null, F_{Gender}) returns an aggregation A1 containing all values that fulfil F_{Gender}, and a bloom filter BF containing all values added to A1
   Choose which Representation R_{2,Age} should be used for Age in Drone 2 and Bins B₂
   A2, BF2=Drone2.AnalyzeGroup(R_{2,Age}, B₂, BF, F_{gender}) returns an aggregation A2 containing all values that fulfil F_{Gender} and are not in BF1, and a bloom filter BF2 containing all values in BF and all values added to A2
   Choose which Representation R_{3,Age} should be used for Age in Drone3 and Bins B₃
   A3, BF3=Drone3.AnalyzeGroup(R_{3,Age}, B₃, BF2, F_{Gender}) returns an aggregation A3 containing all values that fulfil F_{Gender} and are not in BF2, and a bloom filter BF3 containing all values in BF2 and all values added to A3
   Create Aggregate A=A1+A2+A3
   Return A

FIG. 18b shows the group as the ‘first point of entry’. In this arrangement, a list of members of the group for which age is greater than 20 is supplied to a database which holds salary information. Members are outputs aggregated by salary. Note that by using a more complex query structure, the cases of 18a and 18b can be coalesced so that a single query which requests members of the group for which age is greater than 20, in the form of aggregated results organised by salary can be supplied directly to a group. Note that in the case of FIG. 18a the de-duplication within the group which has members providing salary information is done based on a list which is already confined to members of an earlier database that had age greater than 20. In FIG. 18b, the de-duplication is carried out on a group of databases which are attempting to provide a list of members of age greater than 20. In FIG. 18c, the de-duplication is carried out amongst the group members using both factors of the query, the filter age greater than 20 and the desired aggregation metric of salary.

FIG. 18d shows how it is possible to use grouped datasets to provide multidimensional information. According to FIG. 18d, a grouped step of datasets which provides gender information can be used to output a distributed list by gender, wherein each gender is associated with a list of identifiers falling into that gender, once duplicated. These lists are supplied to a group of datasets which provide salary information with a request for an output which is grouped by salary. This allows each salary bin not only to show an aggregated result but to show within that result list of identifiers of each gender falling into that particular salary bin.

FIG. 18e shows a simplified version of this in a single dimensional (salary).

FIG. 18f shows a use case similar to that of 18a, but where the grouped database does not provide salary information but provides some intermediate filter (in this case good customers). The de-duplicated put is then supplied to a salary database.

FIG. 18g is a use case similar to FIG. 18d but noting that the second dimension of salary has a single database rather than a group of databases.

Consider, with reference to FIG. 18g, a query of the form:

```
SELECT RANGES(Drone4.Age, 0, 20, 30, 40, 100)
FROM (
  SELECT EXPLICIT(Group1.Gender, “male”, “female”)
  FROM GROUP(Drone1, Drone2, Drone3) as Group1
  )
```

The controller 2 performs the following steps:
Get Subgraph with drones Drone1, Drone2, Drone3, Drone4
Validate subgraph (as above with reference to FIG. 18a)
Call Query Subquery function with parameters “Group1”, and an empty filter expression F
   a Choose which Representation R_{1,Gender} should be used for Gender for each Drone i (i={1, 2, 3})
   a Create bin-filter Bₘₐₗₑ and B_{female} for each drone [this would be filter expression like ‘gender=“male”’ with the respective representation] a Determine which key K should be returned [best key for key-conversion to Drone4]
   maleFilter1,exF=Drone1.FetchGroup(K, R_{1,Gender}, null, B_{1,male})
      NOTE: exF=exclusive Filter]
   maleFilter2, exF=Drone2.FetchGroup(K, R_{2,Gender}, exF, B_{2,male})
   maleFilter3, exF=Drone3.FetchGroup(K, R_{3,Gender}, exF, B_{3,male})
   Aggregate maleFilter=maleFilter1 union maleFilter2 union maleFilter3
   Apply key-conversion on maleFilter
   Do the same for B_{female}
   return [maleFilter, femaleFilter]
Call Query Analyze function with parameters “Group1” and F (‘gender=“male”’). Handle it as a group:
   Create Bins B=[[0,20), [20,30), [30,40), [40,100)]
   Choose which Representation R_{age} should be used for Age
   maleAgesAggregation=Drone4.Analyze(R_{Age}, B, maleFilter)
   femaleAgesAggregation=Drone4.Analyze(R_{Age}, B, femaleFilter) a Return [maleAgesAggregation, femaleAgesAggregation]

### Notes to Queries:

Drone and Groups can be interchanged in the examples. It is only handled differently in the “Query Subquery” or “Query Analyse” blocks.
Queries can have more than one subquery. In this case each subqueries returns a list of filters that can be applied to the root-query. We run the Cartesian product of all those filters [F_{D1,1}, F_{D1,2}]×[F_{D2,1}, F_{D2,2}, F_{D2,3}] and combine those with a Boolean AND.
A Query with different (or the same) groups in the root and subqueries can be explained by taking the subquery part from FIG. 18g and the Analyze part from FIG. 18a.
Each query and subquery can have its own filter expressions which can be empty in all cases.
Groups can be used in filter expressions (WHERE) too.

### Drone Registration Process

When a new database is to be added to the system, a new drone 50 is initiated at the location (e.g. customer site) of the database. An administrator at the controller 2 manually instigates a new drone registration process which contacts the new drone to cause the new drone to issue a registration request. The administrator adds a drone and gets a JWT (text) and supplies this text to someone who uses this text at the customer site 12. When the drone starts it sends a request including the JWT to the public API 16. On success the response contains a certificate which the drone needs for communication between 42 and 50, and a drone identifier. Drone identifiers are held in a list 44 at the controller 2. The list can be made accessible to customer with access constraints. The drone identifier identifies the drone and its location address to enable queries to be sent to it. Each drone has an association with its database at the customer site. The drone ID also indicates the attributes available to be searched in the database associated with that drone.

As mentioned above, in the response that is returned to a requesting user, the raw set of data entries which have been identified as a result of the multiple queries executed across multiple databases may be returned. Alternatively, the entries can be aggregated into groups according to attributes of the entries. For example, the groups could comprise statistical bins, each bin containing result entries with attributes in a defined parameter range for that attribute. The aggregated data is supplied to a user.

To increase anonymization (that is to decrease the likelihood of a particular data entry in a sparse set being able to be tied to a particular individual who could be identified) a redaction threshold can be applied of a minimum number of entries per bin. Another redaction threshold for entries in all bins could also or alternatively be applied, e.g. “small” bins can be removed.

The redaction process can be applied at a final step (e.g. by the controller 2 upon receipt of the aggregated results from the final dataset E of the group 1), before passing the results to a user device. That is, the controller 2 may redact (not supply to the user device) any bins containing less than a threshold minimum. Performing the redaction in this way can allow for data to remain included (not redacted) in circumstances where one or more individual datasets does not meet (the amount of data entries in at least one bin for that dataset falls below) the redaction threshold, but the group r does. For example, with a redaction threshold of 100 and each dataset A-E returning 30 results, no individual dataset will return any data if the redaction threshold is applied separately. However, if the results are aggregated first, then there may be (taking into account de-duplication of data entries) over 100 results (up to 150) and thus the overall aggregate result need not be redacted.

As mentioned above, the embodiments described herein enable results across a number of different databases to be returned in response to a single query, in a manner which is “hidden” from a requesting user. Moreover, there is no need to join the records of the databases into a common dataset, so there is no requirement for the databases to be under any kind of common control or ownership.

The databases may be at separate geographical locations. The databases may be at separate IP addresses.

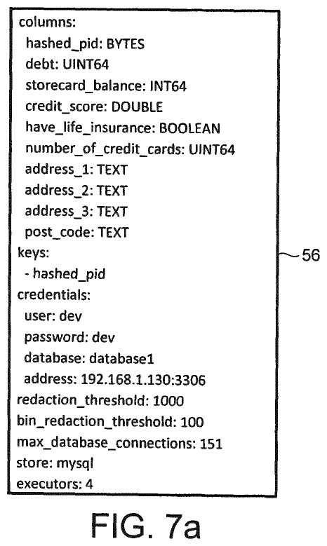

FIG. 8 to FIG. 10 exemplifies the process of querying multiple drones using a single joining key. For example, a combination of filtering expressions A=1 AND B=2 is shown in FIG. 8a to illustrate the use of an “AND” operator 51 for cross examining returned results at the drones 50a, 50b. Wherein an extra filter expression C=3 at drone 50c can be added and the filtering expressions may be represented as a tree in FIG. 8b, i.e. A=1 AND B=2 AND C=3. Each of the drones 50a, 50b and 50c is appropriated with a respective independent database.

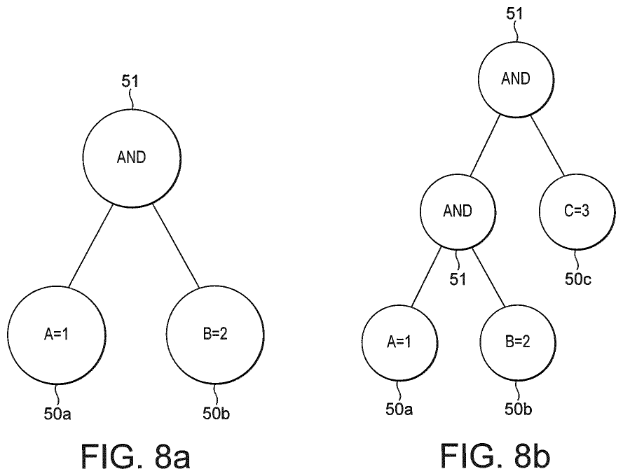

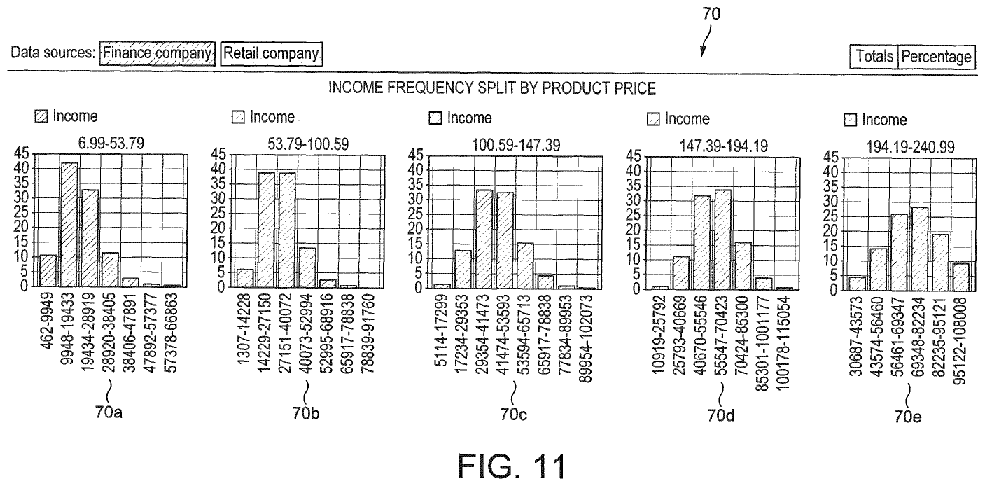

In FIG. 9, the expressions A, B and C in FIG. 11b are replaced with actual filtering expressions (Age>40), (Gender=“male”) and (salary<25000). In this particular example, drone 50a contains both age and gender information and drone 50b contains salary information. Since the filtering expressions (Age>40) and (Gender=“male”) are both operable using a common operator (AND) 51a at drone 50a, they can be operated using a single query (“age>40 and gender=“male”).

In a first scenario where neither drones 50a nor 50b is the target drone, they both count the number of entries fitting their respective filtering expression, as follow, Count (“age>40 and gender=“male”) in drone 50a; and Count (“salary<25000”) in drone 50b;

Assuming the count is relatively lower in drone 50a than that in drone 50b, the two drones then carry out filtering and each returns a filtering set, as follows:

Query (“age>40 and gender=“male”) in drone 50a and return filtering ID set S1; and Query (“salary<25000” and filtering set ID set 1) in drone 50b and return filtering ID set S2 which returns a filtering ID set S2 at most the same amount of elements than in the filtering ID set S1.

The returned filtering ID set S2, which has a higher count, is then sent to the target drone for generating the distribution.

In a second scenario where drone 50b is the target drone, no counting is required at the drones 50a and 50b, since drone 50b will be used to generate the distribution, e.g. the operation comprising the step of Query (“age>40 and gender=“male”) in drone 50a to return filtering set S1, and subsequently sending filtering expression (“salary<25000”) and said filtering set S1 to drone 50b to generate the distribution.

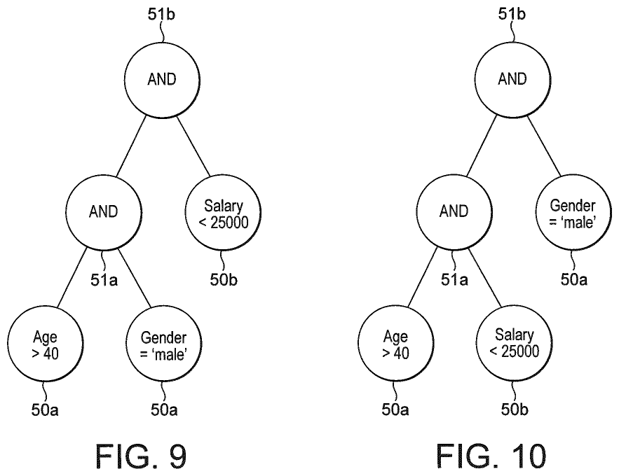

A third scenario is shown in FIG. 10 where the scenario (A+B) and C is changed to (A+C) and B. The query comprises the filtering expression to “(Age>40 and gender.‘male’) and salary<25000”. The process is equivalent to that of the first scenario.

Example queries have the following form:

Target expression WHERE filter expression.

FIG. 11 shows an example output of a user screen 70 for a user which has requested to join data from a finance company and a retail company.

The query Q1 underlying this is:

Distribution (Income) WHERE Distribution (Product Price)

The data shown in the bar graphs 70a-70e in FIG. 11 is income data which shows the number of people having income in certain ranges derived from a finance company. The numerical range on each bar graph differs and represents a product price range derived from the retail company.

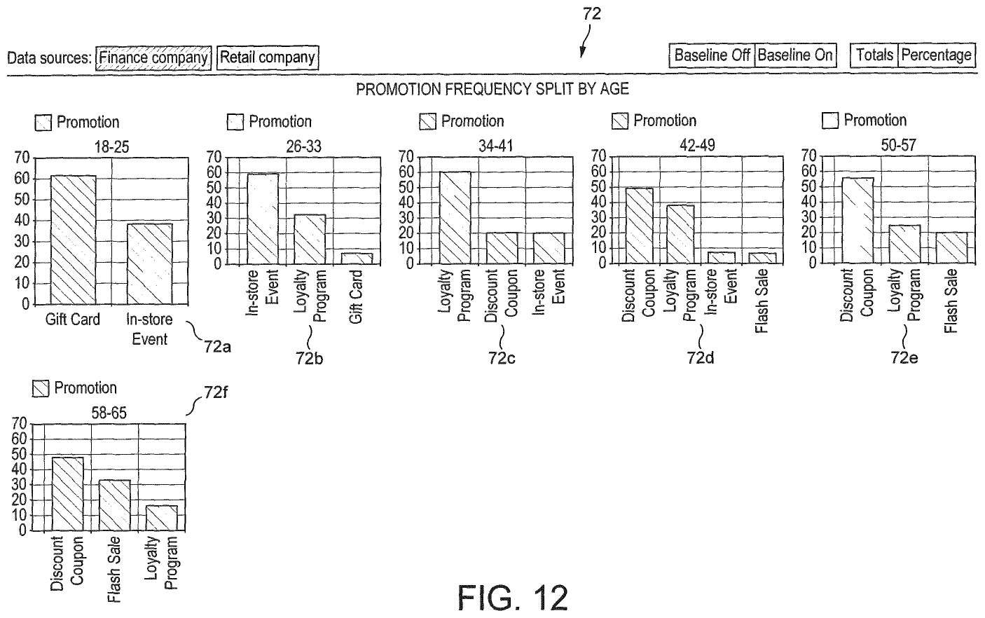

FIG. 12 shows another example. In this example the data from the finance company indicates numbers of people in certain age range with certain income bracket, which is used to provide different bar graphs 72a-70f from the retail company concerning promotion types.

The query Q2 underlying this is:

Distribution (Promotion) WHERE (Distribution (Age) WHERE income>60000)

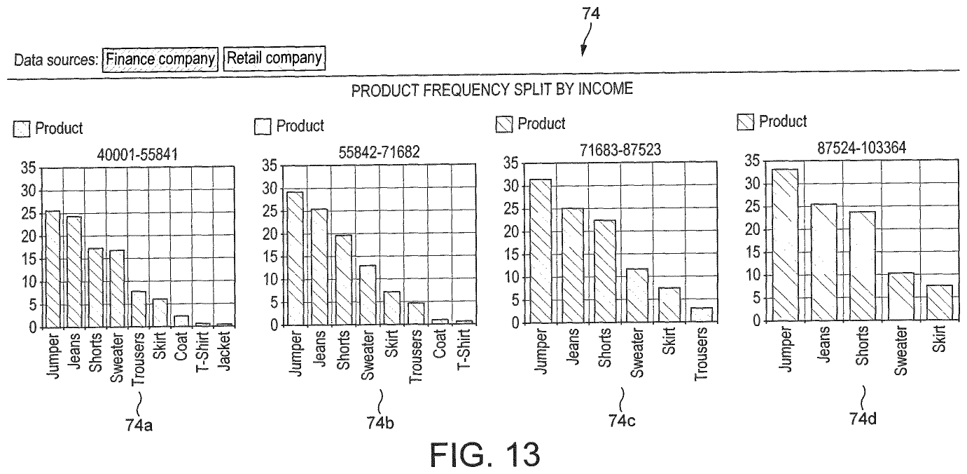

FIG. 13 shows another example where the data from the finance company is used to provide income ranges which are used to generate bar graphs 74a-70d of product frequency from the retail company.

The query Q3 underlying this is:

Distribution (Product) WHERE (Distribution (income) WHERE income>40000 and product_price>80)

Some examples of filter expressions and their use are illustrated in the following table.

| Filter expression | Example use |
|---|---|
| Operator (>, >=, =, !=, <, <=) | age >40, Age >=40, town = “London” |
| Operator between | age between 25 and 30, town between ‘a’ |
| | and ‘b’ |
| Operator in | age in (15, 16, 24, 25), postcode in |
| | (‘RG21 1CE’, ‘RG21 1CD’) |
| Operator like | postcode like ‘RG21 %’ |
| Negated | Not age >40 |
| Combined via AND | age >40 and age >50, town >‘a’ and |
| | town <‘b’ |
| Combined via OR | age >60 or age <15 |

These example filter expressions may be applied to form the following example queries:
distribution(income) where (distribution(gender) where (distribution (age) where job_status !=‘unemployed”)), represents “how is income distributed over genders and ages for not unemployed people”.
distribution (private_health_insurance) where (distribution(age) where (distribution(visits_to_doctor) where age>50 and (income>45000 or retired=true))), represents “how many people have a private health insurance when they are over 50 and earn more than £45000 or are retired” The results are split up into 2 groups that is “age” and “visit_to_doctor” group“.
sum(purchases) where (distribution(purchase_method) where (distribution(town) where (distribution)purchase_month and purchase_time>‘28-10-2015’) where age between 18 and 29 and gender=‘female”, represents “how much money have young females spend on purchases split up in the towns they live in, the month they made the purchase, and the method they used in the last 12 months”.

As mentioned above, the importer module 52 defines the identifiers which will be used in common between the databases. Although it may be desirable to have identifiers which uniquely identify particular entries, it is not necessary for implementation of the concept described herein. It is anticipated that there may be errors where identifiers do not uniquely identify an individual entry, for example, customers having the same first and last names, or a single customer having multiple email addresses. However, error rates in aggregation may be acceptable in some cases. If error rates are not acceptable, mechanisms could be put in place to improve the accuracy, or to triage the identifiers to make sure they are unique.

It is noted that different customer databases may adopt different column headers for the same expression, therefore the importer module can be arranged to carry out normalisation on the column headers so as to produce a unified category (or identifier) for a given expression. The normalised data are exported from the “normal” database 54 to the database 12a against which queries will be run, the database 12a constituting an intermediate recipient database for the purpose of running the queries. It is possible to share high level data statistics between the databases once normalisation is finished, or while the database is being normalised. Normalisation can be carried out manually or automatically.

1. A method of accessing a group of multiple independent databases with an input query to obtain an aggregated output from the group, the method comprising:
searching a first database of the group using the input query to obtain a first set of result entries corresponding to a first set of identifiers in the first database;
aggregating the result entries of the first set into bins defined in the input query according to the attributes of the entries;
providing an indication of the first set of identifiers of the result entries to a second database of the group having a second set of identifiers of entries in the second database;
searching the second database, using the input query, for entries which excludes duplicate identifiers in the first and second sets to obtain a second set of result entries; and
adding to the bins result entries of the second set of result entries according to their attributes.

2. A method according to claim 1, wherein member databases of the group share at least one category of entries.

3. A method according to claim 1 or 2, wherein the input query contains the query expression and the result entries of each database match the query expression.

4. A method according to any preceding claim comprising a step of defining the group from a network of multiple independent databases for a period of a query.

5. A method according to any of claims 1 to 3 comprising the step of defining the group automatically by selecting databases from a network of multiple independent databases based on a property of the input query.

6. A method according to claim 4 or 5, wherein the group is specified in the input query.

7. A method according to claim 4 or 5, wherein the group is defined in a parameter associated with the input query.

8. A method according to any preceding claim comprising the step of receiving the indication of the first set of identifiers from the first database at a controller, and transmitting the indication from the controller to the second database.

9. A method according to claims 1 to 7, comprising the step of transmitting the indication of the first set of identifiers from the first database to the second database.

10. A method according to any preceding claim, wherein the bins are statistical bins, each bin containing result entries with attributes in a predefined parameter range for that attribute.

11. A method according to any of claims 1 to 9, wherein each bin contains result entries of a defined attribute.

12. A method according to claim 10 or 11 comprising a step of applying a redaction threshold of a minimum number of entries per bin to an aggregated set of result entries from all members of the group.

13. A method according to claim 10 or 11 comprising a step of applying a redaction threshold of a total minimum number of result entries.

14. A method according to any preceding claim, wherein the step of providing an indication of the first set of identifiers comprises providing the identifiers in a hashed form or as a bloom filter.

15. A method of accessing multiple independent databases with a single query having multiple expressions, the method comprising:
deriving from a single query at least one filtering query containing at least one filtering expression and a target query containing at least one target expression, wherein the at least one filtering expression is used in a method according to any preceding claim in the input query to access the group of databases and wherein, the second database is a target database which is searched the target expression.

16. A method of accessing multiple independent databases with a single query having multiple expressions, the method comprising:
deriving from the single query at least one filtering query containing at least one filtering expression and a target query containing at least one target expression;
searching a first one of the multiple independent databases using the at least one filtering query to obtain a filtering set of target entries matching the at least one filtering expression;
applying identifiers only of the filtering set of target entries and the target query to a group of multiple independent databases in accordance with a method of any of claims 1 to 14, wherein the target expression is in the input query for the group.

17. A method according to any preceding claim, wherein each bin contains an aggregated number of entries.

18. A method according to any preceding claim, wherein each bin contains an indication of a set of identifiers in that bin.

19. A method according to any preceding claim, wherein member databases of the group contain entries in the same field of use.

20. A method according to any preceding claim, wherein duplicate identifiers are excluded by comparing the indicating of the first set of identifiers with the second set of identifiers prior to the step searching the second database, wherein the step of searching the second database applies only additional identifiers in the second set and not in the first set.

21. A method according to any of claims 1 to 19, wherein duplicate identifiers are excluded by comparing each identifier of the second set with indication of the first set while searching the second database.

22. A computer program product comprising computer-executable code embodied on a computer-readable storage medium, configured so as when executed by at least one processor to perform the method steps of claim 1 or any claim dependent thereon.

23. A computer device for accessing a group of multiple independent databases with an input query to obtain an aggregated output from the group, the computer device comprising at least one processing configured to:
search a first database of the group using the input query to obtain a first set of result entries corresponding to a first set of identifiers in the first database;
aggregate the result entries of the first set into bins defined in the input query according to the attributes of the entries;
provide an indication of the first set of identifiers of the result entries to a second database of the group having a second set of identifiers of entries in the second database;
search the second database, using the input query, for entries which excludes duplicate identifiers in the first and second sets to obtain a second set of result entries; and
add to the bins result entries of the second set of result entries according to their attributes.

24. A method of extracting data from a dynamically defined group of multiple independent databases in a common field of use, wherein each database is owned by a data owner and holds data entries each having a key and a parameter in at least one category, wherein data entries of each database are constrained from being transferred to another data owner, the method comprising:
accessing a first one of the databases to extract results based on an input query defined for the dynamically defined group to produce a first set of results in the category;
accessing a second one of the databases to extract results based on the same input query, while de-duplicating keys returned from the first database, to produce a second set of results in the category; and
aggregating the first and second sets of results without identifying the origin database of each result into an aggregated set for that category.
